(19) United States
(12) Patent Application Publication
(10) Pub. No.: US 2010/0147809 A1
(43) Pub. Date: Jun. 17, 2010

(54) Method of Laser Welding

(75) Inventors: Axel Geisler, Burscheid (DE); Matthew Cooper, Köln (DE); Andreas Schmitter, Wuppertal (DE); Michael Hamers, Biedenkopf (DE); Vincenzo Oliva, Hürth (DE)

Correspondence Address: FOLEY & LARDNER LLP, 777 EAST WISCONSIN AVENUE, MILWAUKEE, WI, 53202-5306, US

(73) Assignee: Johnson Controls GMBH

(21) Appl. No.: 11/794,951

(22) PCT Filed: Jan. 10, 2006
(86) PCT No.: PCT/EP06/50129

§ 371 Date: Jul. 17, 2009

(30) Foreign Application Priority Data
Jan. 12, 2005 (DE) 10 2005 001 606.5

(51) Int. Cl. B23K 26/00

(52) U.S. Cl. 219/121.64

(57) ABSTRACT

A method of joining at least one first metal sheet and a second metal sheet by laser welding includes at least partially stacking the at least one first metal sheet and the second metal sheet on top of one another to form an overlap region and welding together the at least one first metal sheet and the second metal sheet in the overlap region along an oscillating line. Welding along an oscillating line creates a longer weld seam in comparison to welding along a straight line, thereby increasing the strength of the weld seam.

### CROSS-REFERENCE TO RELATED PATENT APPLICATIONS

The present application is a National Stage of International Application No. PCT/EP2006/050129 filed on Jan. 10, 2006, which claims the benefit of German Patent Application No. 10 2005 001 606.5 filed on Jan. 12, 2005. The entire disclosures of International Application No. PCT/EP2006/050129 and German Patent Application No. 10 2005 001 606.5 are incorporated herein by reference.

### BACKGROUND

The present disclosure relates to a method for joining at least one first metal sheet and a second metal sheet by laser welding wherein the sheets are at least partially stacked on top of one another to form an overlap region. The present disclosure also relates to a method for joining at least three metal sheets by laser welding. The present disclosure further relates to the use of the methods and to a component produced by means of one of the methods.

The fuel consumption of motor vehicles increases with the weight to be transported. It is generally known in the vehicle industry, particularly in the motor vehicle industry, that the increasing number of components used to provide the ever increasing comfort of a vehicle increases the curb weight of a vehicle. Accordingly, in the vehicle industry, it is desirable to optimize the weight of the components of the vehicle.

Furthermore, durability of the components in the vehicles under high loads (e.g., vibrations when driving a motor vehicle on uneven ground) and a high level of safety (e.g., in the event of an accident) is demanded, and therefore, the components have to exhibit high rigidity and strength.

### SUMMARY

One exemplary embodiment relates to a method of joining at least one first metal sheet and a second metal sheet by laser welding. The method includes at least partially stacking the at least one first metal sheet and the second metal sheet on top of one another to form an overlap region and welding together the at least one first metal sheet and the second metal sheet in the overlap region along an oscillating line.

Another exemplary embodiment relates to a method of joining at least three sheets by laser welding. The method includes at least partially stacking a first sheet, a second sheet and a third sheet on top of one another in such a way that they form an overlap region, providing a laser above the overlap region and welding together the first sheet, the second sheet and the third sheet in the overlap region along an oscillating line. The first sheet, the second sheet and the third sheet are stacked with decreasing thickness in the direction towards the laser.

### BRIEF DESCRIPTION OF THE DRAWINGS

It should be noted that the figures are merely exemplary and do not limit the scope of the appended claims.

FIG. 1a is a side view of a component produced by means of a laser welding method according to an exemplary embodiment.

FIG. 1b is a front view of the component of FIG. 1.

FIG. 2 shows a component produced by means of a laser welding method according to another exemplary embodiment.

FIG. 3 shows the stacking and simultaneous welding of sheets with decreasing sheet thickness in a direction towards a laser.

FIGS. 4a and 4b show the stacking and stepwise welding of sheets with decreasing sheet thickness in a direction towards a laser.

FIG. 5 shows an embossing of a sheet and the arrangement of a weld seam.

FIG. 6 shows a first sheet with a flange on a second sheet.

FIG. 7 shows diagrammatically a comparison of the load-bearing strength of several weld seams produced by means of the laser welding methods disclosed herein with a weld seam produced by means of a conventional resistance spot welding method.

FIG. 8 shows a cross section of a component produced by means of a laser welding method disclosed herein.

FIG. 9 shows a frame of a backrest for a motor vehicle seat produced by means of a laser welding method disclosed herein.

### DETAILED DESCRIPTION

According to an exemplary embodiment, a method for joining at least one first metal sheet and a second metal sheet by means of laser welding is provided. The sheets are at least partially stacked on top of one another to form an overlap region and are welded together in the overlap region along an oscillating line after stacking.

For purposes of the present disclosure, use of the phrase “oscillating line” is used broadly to refer to the line that a laser beam of a laser performs on a sheet (e.g., metal sheet) facing towards the laser. The person skilled in the art understands that the contour of the oscillating line along which the sheets are welded together essentially corresponds to the contour of the weld seam created during welding.

As a result of welding along the oscillating line, the weld seam created becomes longer compared with welding along a straight line, whereby the straight line corresponds to the projection of the oscillating line onto an axis that intersects the oscillating line at least in two points. Since the weld seam created during welding of the sheets along the oscillating line is longer than the weld seam created during welding along a straight line, the strength of the weld seam is higher.

In view of the higher strength of its weld seams, a component produced by this method has a higher strength and rigidity, and is therefore both more durable and can withstand higher loads. On the other hand, the thickness of the sheets can thus be reduced, if necessary, so that although the rigidity and strength of the produced component is not higher or is not significantly higher, the weight of the component is reduced. The method of welding with an oscillating line thus permits an optimization of the components with respect to their strength and rigidity on the one hand, and with respect to their weight on the other hand.

According to an exemplary embodiment, the oscillating line has an essentially wave-shaped form. The person skilled in the art understands that other essentially random courses of the oscillating line are also possible (e.g., a curved, zigzag or round course of the oscillating line). With a zigzag course of the oscillating line, however, stress peaks may occur in the weld seam that may cause the weld seam to crack, while the stress curve with a wave-shaped or curved oscillating line is more homogeneous. A round course, on the other hand, requires the laser and/or the sheets to be moved back. A zigzag or round course of the oscillating line may thus be less than optimal with respect to the speed during the production of the weld seam and/or with respect to the transport of the sheet(s). With a wave-shaped course, the laser and/or the sheets can be moved uniformly so that the speed of assembly (e.g., with respect to the welding times) is optimized.

According to an exemplary embodiment, the amplitude and/or wavelength of a wave-shaped course of the oscillating line can be varied depending on the space available for the component to be produced. The person skilled in the art understands that due to the contact-free method of laser welding, this method can be employed in regions of components that are considerably more difficult to access than with other welding methods that require contact with the sheets to be welded (e.g., resistance spot welding). In particular, as by contrast with resistance spot welding, laser welding requires access from only one side. The width of a region of the component intended for welding (e.g., the width of a flange) can therefore be chosen smaller than when welding by means of a welding method requiring contact with the sheets to be welded. In particular, with a complex form of the sheets or of the component to be produced. The size of the sheet(s) required is thus smaller so that the weight of the component to be produced is reduced.

The strength of the weld seam and the rigidity of the component increases with an increase in the amplitude or a reduction in the wavelength of the wave-shaped oscillating seam due to the increase in the length of the weld seam by comparison with a weld seam in a straight line. As such, the strength of the weld seam and the rigidity of the component can be set by varying the amplitude and wavelength of the oscillating line.

According to an exemplary embodiment, the sheets have an overlap region during welding rather than being welded together by a butt welding method in which they have to be placed very accurately against one another. Due to the welding along the oscillating line, which permits a greater tolerance for insertion of the sheets, no greater insertion accuracy of the sheets is necessary than for the conventional resistance spot welding.

According to an exemplary embodiment, a laser is provided above the overlap region of the sheets. According to another exemplary embodiment, the sheets are completely melted over their full thickness in the area of the weld seam so that they form an essentially optimum joint on solidification.

According to an exemplary embodiment, the oscillating line runs at an angle to the direction of the main load. For example, the oscillating line may run essentially transversely to the direction of the main load. According to an exemplary embodiment, the oscillating line runs at an angle of approximately 45 degrees relative to the direction of the main load. For purposes of the present disclosure, the phrase “direction of the main load” is used broadly to refer to the direction in which the weld seam is essentially loaded during use of the finished component. Providing the oscillating line at an angle to the direction of the main load makes the strength of the resulting weld seam against forces loading the component in or opposite the direction of the main load higher. The force that can be transmitted by means of the weld seam is therefore higher with a course of the oscillating line at an angle to the direction of the main load, and may be particularly high with a course at an angle of approximately 45 degrees.

According to an exemplary embodiment, the length of the oscillating line is between 10 mm and 25 mm. For example, the length of the oscillating line may be between 15 mm and 20 mm. The person skilled in the art understands that the length of the oscillating line is dependent on the required strength of the weld seam and/or on the required strength and rigidity of the component and on the thickness of the sheets used.

According to an exemplary embodiment, the first sheet and the second sheet have a different thickness and are stacked with decreasing thickness in the direction towards the laser. Depending on the clamping device employed, stacking of the sheets with decreasing thickness in the direction towards the laser may also be advantageous since the thinner sheet has a lower rigidity than the thicker sheet, and hence the stacking of the thinner sheet on the thicker sheet and the subsequent clamping can be performed more easily and more quickly. The insertion times of the sheets during assembly are thus reduced.

According to another exemplary embodiment, at least three metal sheets are at least partially stacked on top of one another in such a way that they form an overlap region and are joined together by means of laser welding. According to an exemplary embodiment, all the sheets are stacked with decreasing thickness in the direction towards the laser and are then jointly welded together. According to another exemplary embodiment, the at least two thickest sheets are stacked with decreasing thickness in the direction towards the laser and welded together, and then the next thinner or the thinner sheets are stacked on the welded thicker sheets with decreasing thickness in the direction towards the laser and are welded to the latter. According to another exemplary embodiment, the stacking of the thinner sheet(s) with decreasing thickness in the direction towards the laser on already welded thicker sheets, and the subsequent welding of the stacked sheets in each case, is repeated several times until all the sheets are welded together.

The stepwise welding together of the sheets disclosed in the above-mentioned second and third sub-point is advantageous with respect to the accessibility of the sheets during the assembly since laser welding requires accessibility from only one side. In addition, the stepwise welding of the sheets allows a laser with a lower energy input to be used than for the simultaneous welding together of all the sheets. The strength of the weld seam is maintained by using a laser with which the thickest sheets are essentially completely melted along their thickness during welding. As the thicker sheets are already essentially optimally welded to one another, it is only necessary to ensure during welding of thinner sheets that the weld seam of the thinner sheets to at least the next thicker (adjacent) sheet is essentially optimal.

Simultaneous welding together of all the sheets, on the other hand, makes assembly faster.

When the at least three sheets are stacked with decreasing thickness in the direction towards the laser, the use of laser welding ensures that an optimal weld seam with respect to the strength is produced. By contrast with this method, provision of the most symmetrical structure of the sheets possible in the welding area is preferred when using resistance spot welding so that when using three sheets of different thickness, for example, the thinnest sheet is arranged in the middle so that the distance between the contact surfaces of the sheets and the two electrodes is as equal as possible. Inert gas shielded arc welding conventionally provides only for the welding of two stacked sheets.

According to an exemplary embodiment, an embossing is provided in at least one sheet in the overlap region. The embossing equalizes wavinesses of the sheet(s) to be welded together and the sheets are essentially in contact with one another in the area of the embossing. The distance between the sheets is thus essentially minimal in the area of the weld seam. According to an exemplary embodiment, the embossing is provided in the thicker sheet as the thinner sheet can adapt more easily to the contour of the thicker sheet.

According to an exemplary embodiment, the method of laser welding using an oscillating line is used for the production of a component for a vehicle (e.g., a motor vehicle). In particular, the method may be used for the production of a frame of a motor vehicle seat. Optimized components can be produced as a result of the method of welding along the oscillating line and the resulting high strength of the weld seam with respect to its weight and its rigidity and strength. The method thus requires no greater insertion precision of the sheets during assembly than is necessary, for example, for conventional resistance spot welding. The strength of the weld seam is particularly high. In particular, the strength of the weld seam may be increased if the direction of the main load is taken into consideration and the oscillating line is arranged at an angle to the direction of the main load (e.g., an angle of approximately 45 degrees). The stacking of the sheets with decreasing thickness in the direction towards the laser may be advantageous with respect to the accessibility of the sheets during the assembly. The simultaneous welding together of all the sheets is particularly fast. This stacking may be simpler and faster with respect to the insertion and clamping of the sheets during assembly, and is thus inexpensive.

According to an exemplary embodiment, a component is produced by means of the laser welding method using an oscillating line. According to an exemplary embodiment, the component is a frame of a motor vehicle seat. The person skilled in the art understands that the component can be a random component in which the force to be transmitted by means of the weld seam is high and/or that is simple and quick to assemble.

According to an exemplary embodiment, the method can be used for both metallic sheets and for thermoplastic sheets.

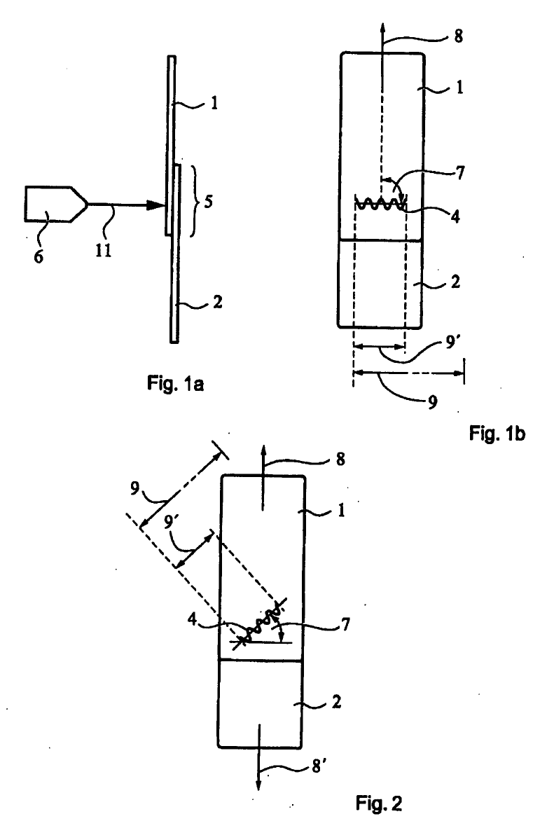

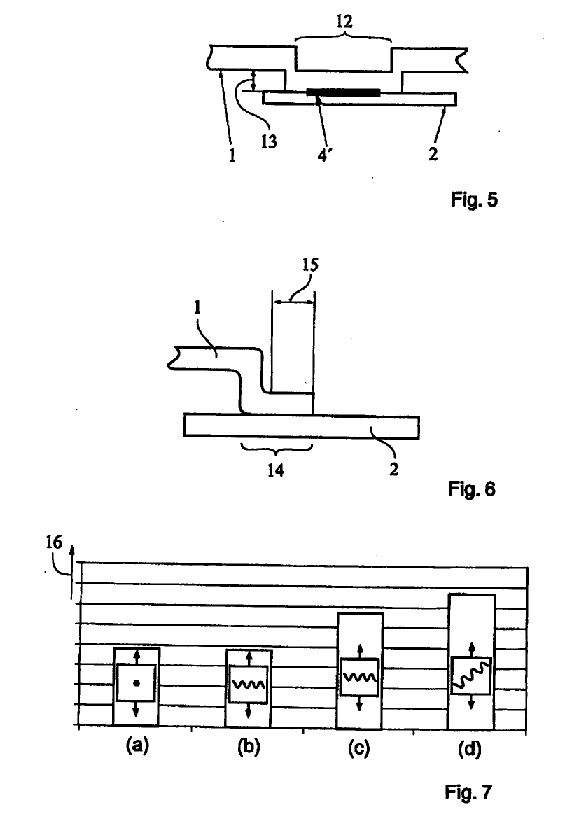

Referring now to the FIGURES, and to FIGS. 1a and 1b in particular, a component produced by means of a laser welding method is shown according to an exemplary embodiment. FIG. 1a shows a side view of the component while FIG. 1b shows a front view. The component is shown as including a first sheet 1 and a second sheet 2. The sheets 1, 2 are at least partially stacked on top of one another so that they form an overlap region 5. FIG. 1a shows the arrangement of a laser 6 above the overlap region 5 of the sheets 1, 2 and a laser beam 11 emanating from the laser 6 during welding of the sheets 1, 2. Laser beam 11 is shown as striking the sheet 1 at a surface facing towards the laser 6. FIG. 1b shows an oscillating line 4 along which the sheets 1, 2 are welded together. The length of the oscillating line 4, indicated diagrammatically by an arrow 9, is longer than the length of a straight line indicated by an arrow 9′ that corresponds to the projection of the oscillating line 4 onto an axis passing through at least two points of the oscillating line 4. An arrow 8 indicates the direction of a main load on a weld seam 4′ created during welding together of the sheets 1, 2 along the oscillating line 4 (see FIG. 5). The direction of the main load 8 is arranged at an angle 7 of approximately 90 degrees to the oscillating line 4.

Referring to FIG. 2, another component is shown according to an exemplary embodiment. Similar to the exemplary embodiment illustrated in FIGS. 1a and 1b, the exemplary embodiment illustrated in FIG. 2 includes a first sheet 1 and a second sheet 2. However, in contrast to the exemplary embodiment illustrated in FIGS. 1a and 1b, the exemplary embodiment illustrated in FIG. 2 includes an oscillating line 4 arranged at an angle 7 of approximately 45° degrees to the direction of the main load 8. The arrow 8′ indicates the direction opposite the direction of the main load 8. FIG. 2 also shows diagrammatically the length of the oscillating line 9 and the length of the straight line 9′.

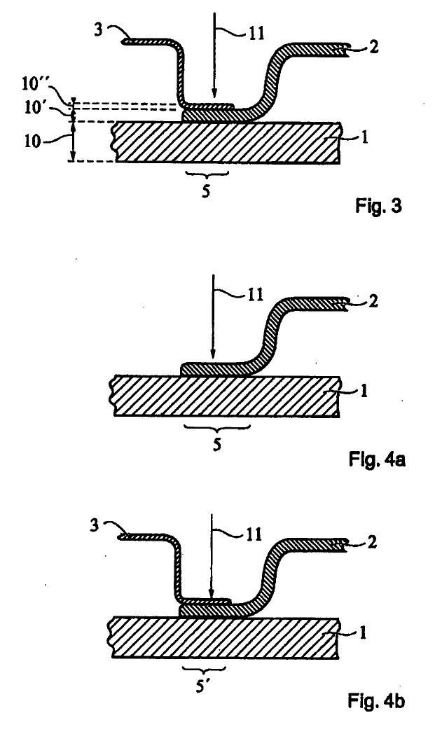

FIG. 3 shows the stacking and simultaneous welding of multiple sheets. According to the embodiment illustrated, three sheets, sheets 1, 2, 3 with decreasing sheet thickness 10, 10′, 10″ in the direction towards the laser 6 (see FIG. 1), are welded together. The sheets 1, 2, 3 form an overlap region 5. Arranged above the overlap region 5 is the laser 6, indicated by the laser beam 11. According to an exemplary embodiment, the sheets 1, 2, 3 are welded together simultaneously.

FIGS. 4a and 4b show the stacking and stepwise welding of multiple sheets. According to the embodiment illustrated, three sheets, sheets 1, 2, 3 with decreasing sheet thickness 10, 10′, 10″ in the direction towards the laser 6, are welded together in a stepwise manner. Once again, laser 6 is indicated by means of a laser beam 11 and with respect to the sheet thickness 10, 10′, 10″ (see FIG. 3). FIG. 4a shows the welding of the two thicker sheets 1, 2 in their overlap region 5. FIG. 4b shows the subsequent welding of the thinnest sheet 3 to the two already welded thicker sheets 1, 2 in their overlap region 5′.

FIG. 5 shows an embossing 12 of a sheet 1 and the arrangement of a weld seam 4′ between the sheet 1 and a second sheet 2 essentially in contact with the embossing 12. In the area outside the embossing 12, a distance 13 between the first and the second sheet is essentially determined by the depth of the embossing 12. According to an exemplary embodiment, distance 13 is between approximately 1/10 mm and approximately 8/10 mm. For example, the distance 13 may be approximately 5/10 mm. According to an exemplary embodiment, weld seam 4′ is provided inside the embossing 12.

FIG. 6 shows a first sheet 1 with a flange 14 on a second sheet 2. An arrow indicates a width 15 of the flange 14 required for welding of the sheets 1, 2 by means of a laser welding process using an oscillating line. According to an exemplary embodiment, the width 15 is between 6 mm and 10 mm. For example, the width 15 may be approximately 8 mm. According to an exemplary embodiment, an embossing 12 (see FIG. 5) is made in the area of the width 15 of the flange 14 indicated by the arrow on one of the two sheets 1, 2.

FIG. 7 is a graphic illustration showing a comparison of the load-bearing strength of several weld seams 4′ produced by means of the laser welding method using an oscillating line (see FIG. 5), with a weld seam produced by means of a conventional resistance spot welding method. Illustration (a) shows the force that can be transmitted by the weld seam when the weld seam is produced by means of the resistance spot welding method. The transmittable force is shown diagrammatically in vertical direction on the scale and indicated by an arrow 16. Illustration (b) shows the force that can be transmitted by the weld seam when the weld seam is produced by means of a laser welding method using an oscillating line. The oscillating line 4 in illustration (b) has a length 9 of approximately 10 mm and an angle 7 of approximately 90 degrees to the direction of the main load 8 of the weld seam 4′ (see FIGS. 1b and 2). As shown, the transmittable force of a weld seam 4′ produced by means of the laser welding method using an oscillating line is comparable with the transmittable force of a weld seam produced by means of the resistance spot welding method. Illustration (c) shows the force that can be transmitted by the weld seam when the weld seam is produced by means of a laser welding method using an oscillating line and the oscillating line has a length 9 of approximately 20 mm. As shown, the force that can be transmitted by means of the weld seam 4′ in illustration (c) is significantly higher than the force that can be transmitted by illustrations (a) and (b). The transmittable force can be significantly increased once again if the oscillating line 4 is arranged at an angle 7 of approximately 45 degrees to the direction of the main load 8, as shown in illustration (d), and not at an angle 7 of approximately 90 degrees.

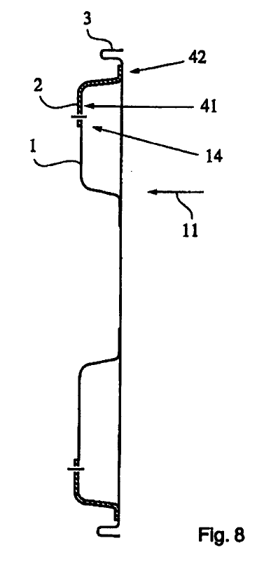

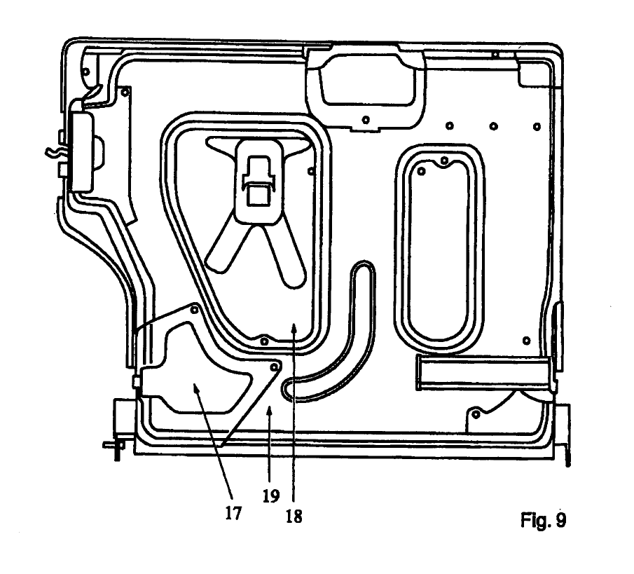

FIG. 8 shows a cross section of a component produced by means of a laser welding method using an oscillating line. The component is made from a plurality of sheets 1, 2, 3 of different thickness. In order to ensure accessibility to the necessary welding points, the first sheet 1 and the second sheet 2 are first welded together at a first welding point 41, whereby the sheets 1, 2 are arranged with decreasing thickness in the direction towards the laser 6 (the laser 6 being indicated here by the laser beam 11). The arrangement and/or clamping of the sheets 1, 2 is indicated by means of a tool mounting 16. In the second step, the third sheet 3 is welded to the first sheet 1 and the second sheet 2 at a second welding point 42, whereby the third sheet 3 is thinner than the first and the second sheet 1, 2.

FIG. 9 shows a frame of a backrest of a motor vehicle seat produced by means of a laser welding method using an oscillating line. First pivot brackets 17 of the seat made from the thickest sheet are arranged on a turntable (not visible here). A reinforcement frame 19 is then arranged on the pivot brackets 17. The parts (i.e., first pivot brackets 17 and reinforcement frame 19) are clamped together and finally welded together by means of a laser welding method using an oscillating line. This is followed by positioning and clamping of a back panel 18 on the same or another turntable (also not visible here) and welding to the already welded reinforcement frame 19 and pivot brackets 17. The weld seam areas have an embossing 12 that is not visible here so that the distance between the sheets 17, 18, 19 is as small as possible in the area of the weld seam. According to an exemplary embodiment, the embossing 12 is made in the thicker sheets in each case, in other words here in the pivot brackets 17 when welding the pivot brackets 17 to the reinforcement frame 19, and in the reinforcement frame 19 when welding the back panel 18 to the reinforcement frame 19. According to an exemplary embodiment, the back panel 18 can adapt very well to the contour of the reinforcement frame 19 as it is very thin.

1. A method for joining at least one first metal sheet and a second metal sheet by laser welding, the method comprising:
at least partially stacking the at least one first metal sheet and the second metal sheet on top of one another to form an overlap region; and
welding together the at least one first metal sheet and the second metal sheet in the overlap region along an oscillating line to form a weld seam.

2. The method of claim 1 wherein the oscillating line has an essentially wave-shaped form.

3. The method of claim 1 further comprising providing a laser above the overlap region of the at least one first metal sheet and the second metal sheet.

4. The method of claim 1 wherein the oscillating line runs at an angle to the direction of a main load, applied to the weld seam.

5. The method of claim 1 wherein the length of the oscillating line is between approximately 10 mm and approximately 25 mm.

6. The method of claim 3 wherein the at least one first sheet and the second sheet have a different thickness and are stacked with decreasing thickness in the direction towards the laser.

7. A method for joining at least three sheets by laser welding, the method comprising:
at least partially stacking a first sheet, a second sheet and a third sheet on top of one another in such a way that they form an overlap region;
providing a laser above the overlap region; and
welding together the first sheet, the second sheet and the third sheet in the overlap region along an oscillating line,
wherein the first sheet, the second sheet and the third sheet are stacked with decreasing thickness in the direction towards the laser.

8. The method of claim 7 further comprising providing an embossing in at least one of the first sheet, the second sheet and the third sheet in the overlap region.

9. The method of claim 7 wherein the method is used for production of a component for a vehicle.

10. (canceled)

11. The method of claim 9 wherein the component is a frame of a motor vehicle seat.

12. The method of claim 4 wherein the oscillating line runs substantially transverse to the direction of the main load.

13. The method of claim 12 wherein the angle is approximately 45 degrees.

14. The method of claim 5 wherein the length of the oscillating line is between approximately 15 mm and approximately 20 mm.

15. The method of claim 7 wherein welding together the first sheet, the second sheet and the third sheet comprises welding the first sheet, the second sheet and the third sheet together after all of the sheets are stacked with decreasing thickness in the direction towards the laser.

16. The method of claim 7 wherein stacking the first sheet, the second sheet and the third sheet and welding together the first sheet, the second sheet and the third sheet comprises:
stacking the two thickest sheets of the first sheet, the second sheet and the third sheet with decreasing thickness in the direction towards the laser;
welding together the two thickest sheets;
stacking the remaining sheet on the welded thicker sheets with decreasing thickness in the direction towards the laser; and
welding the remaining sheet to the welded thicker sheets.

17. The method of claim 7 wherein stacking the first sheet, the second sheet and the third sheet and welding together the first sheet, the second sheet and the third sheet comprises:
selecting two sheets of the first sheet, the second sheet and the third sheet;
stacking the selected sheets with decreasing thickness in the direction towards the laser;
welding together the selected sheets;
stacking the remaining sheet on the welded selected sheets with decreasing thickness in the direction towards the laser; and
welding the remaining sheet to the welded selected sheets.

18. A vehicle component comprising:
a first sheet;
a second sheet at least partially stacked on top of the first sheet to form an overlap region; and
a weld seam provided in the overlap region for securing the first sheet to the second sheet, the weld seam being formed along an oscillating line.

19. The vehicle component of claim 18 further comprising a third sheet at least partially stacked on top of the second sheet, the third sheet having a thickness that is thinner than a thickness of the second sheet, which is in turn thinner than a thickness of the first sheet.

20. The vehicle component of claim 18 further comprising an embossing in at least one of the first sheet and the second sheet in the overlap region.

21. The vehicle component of claim 18 wherein the weld seam is provided at an angle of approximately 45 degrees relative to a main load applied to the weld seam.
